(19) United States
(12) Patent Application Publication
(10) Pub. No.: US 2023/0121258 A1
(43) Pub. Date: Apr. 20, 2023

(54) Device for the automated vertical take-off, vertical landing, and/or handling of an aerial vehicle with the aid of a robot, aerial vehicle, and end effector

(71) Applicant: Quantum-Systems GmbH, Gilching (DE)

(72) Inventors: Fabian Benedikt, Germering (DE); Matthias Hecht, Kumhausen (DE); Moritz Maier, München (DE); Florian Seibel, Herrsching (DE)

(21) Appl. No.: 17/965,322

(22) Filed: Oct. 13, 2022

(30) Foreign Application Priority Data
Oct. 14, 2021 (DE) 10 2021 126 688.2

(51) Int. Cl. B64F 1/02; B25J 15/00

(52) U.S. Cl. CPC B64F 1/02; B25J 15/0019; B64C 29/00

(57) ABSTRACT

A device for the automated vertical take-off, vertical landing, and/or handling of an aerial vehicle with the aid of a robot, the device including a first connection module and a second connection module, each including a capture and/or release section that is active in a capture and/or release phase and a guide section that is active in a guide phase, and the first connection module and the second connection module being lockable in a holding position. An aerial vehicle capable of automatedly vertically taking off, vertically landing, or being handled with the aid of a robot, the aerial vehicle including a first connection module or a second connection module of such a device. An end effector for a robot for the automated vertical take-off, vertical landing, and/or handling of an aerial vehicle, the end effector including a second connection module or a first connection module of such a device.

The present invention relates to a device for the automated vertical take-off, vertical landing, and/or handling of an aerial vehicle with the aid of a robot, the device including a first connection module and a second connection module. Moreover, the present invention relates to an aerial vehicle, the aerial vehicle being capable of automatedly vertically taking off, vertically landing, or being handled with the aid of a robot. Furthermore, the present invention relates to an end effector for the automated vertical take-off, vertical landing, and/or handling of an aerial vehicle.

### BACKGROUND

The document WO 2013/171735 A1 relates to point take-off and landing systems for an unmanned flying object. In one specific embodiment, the flying object is guided along a flight trajectory and approaches a landing body so that a latching element, which is coupled to a suspension cable suspended at the flying body, latches with a receiving latch that is coupled to an extendable, retractable rod that protrudes horizontally from a side surface of the landing body. A mechanism for releasing/retracting the cable engages with the suspension cable and then releases or retracts the suspension cable. The rod is moved so that the flying object is pulled onto a landing surface. In another specific embodiment, the flying object is guided along a flight trajectory and approaches a landing body so that a latching element, which is coupled to a suspension cable suspended at the flying body, latches with a receiving cable that is supported by cable supports that protrude vertically from the top side of the landing body. A mechanism for releasing/retracting the cable releases or retracts the suspension cable, as the result of which the flying object is pulled onto the landing surface.

The document WO 2021/010869 A1 relates to the design of a landing platform for an unmanned aerial vehicle (referred to below as UAV) which takes off and lands vertically, and which may be used in the development of automatic UAV charging and maintenance stations. A landing platform for a vertical take-off and landing UAV includes a landing surface, electrical contacts, and a UAV positioning device. The positioning device is made up of iris diaphragms that are connected to an opening/closing drive. According to another specific embodiment, the positioning device is made up of iris diaphragms that are connected to an opening/closing drive, and funnels, the total number of iris diaphragms and funnels being no greater than the maximum number of UAV supports.

The document US 2006/0249623 A1 relates to a platform for launching and/or capturing an unmanned aerial vehicle (UAV), in particular a small UAV. The launch/capture platform includes a frame, a floor attached to the frame that is capable of supporting the UAV, means for detecting and tracking the UAV in flight, a connector, and a connector controller that connects the platform to an external support structure and that provides a controllable, adaptive movement of the platform in response to the approaching UAV position and attitude, means for launching the UAV from the platform and for capturing an in-flight UAV on the platform, and means for locking down the UAV between the capture and the launch of the UAV. A further specific embodiment of the present invention that is directed to a method for capturing a small in-flight UAV includes providing a UAV capture platform, providing a UAV capturing means as an integrated component of the platform, providing means for determining in real time the relative position of an engaging section of the capturing means with respect to an approaching in-flight UAV, providing means for automatically maneuvering the engaging section of the capturing means with respect to at least one of a position and an attitude of the approaching in-flight UAV, capturing the UAV, and securing the captured UAV to the capture platform.

The document US 2019/0126478 A1 relates to a device and a system for launching and/or capturing an unmanned aerial vehicle (UAV). The device includes a movable substrate with an electromagnetic end effector, and a UAV with a metallic strike plate that is attracted by the end effector when the electromagnet is activated. The system includes a movable robotic arm with a free end and a secured end; an electromagnetic end effector that is connected in the vicinity of the free end of the robotic arm; a UAV with a metallic strike plate that is attracted and held by the electromagnetic end effector when the electromagnetic end effector is active; flight trajectory software that is configured in such a way that it controls a location of the free end of the robotic arm; and a control module for receiving input data, analyzing the data, and using the flight trajectory software to control the location of the electromagnetic end effector and to activate or deactivate same. Methods for launching and capturing the UAV are also described.

The document EP 3 124 381 A1 relates to a device for accommodating and charging an unmanned vertical take-off and landing (VTOL) aircraft. To provide a device for accommodating and charging an unmanned vertical take-off and landing aircraft in the form of a post affixed in the ground, in the document EP 3 124 381 A1 it is provided that the device includes the following: a post that is placed on a base surface, and at least one lateral fastening hole that is formed in a side of the post and configured in such a way that a rod of the unmanned VTOL aircraft is inserted into the lateral fastening hole and fastened; an entrance of the lateral fastening hole being formed in a conical shape so that the rod of the unmanned VTOL aircraft may be easily inserted into the lateral fastening hole during the fastening of the unmanned VTOL aircraft; and the lateral fastening hole also being configured in such a way that target- and cross-shaped LED/IR lights light up to guide the unmanned VTOL aircraft by automatic insertion via the view of the unmanned VTOL aircraft.

### SUMMARY OF THE INVENTION

An object of the present invention is to structurally and/or functionally improve a device mentioned at the outset. An alternator additional object of the present invention is to structurally and/or functionally improve an aerial vehicle mentioned at the outset. An alternate or additional object of the present invention is to structurally and/or functionally improve an end effector mentioned at the outset.

The present disclosure provides a device (102) for the automated vertical take-off, vertical landing, and/or handling of an aerial vehicle (104) with the aid of a robot, the device (102) including a first connection module (100) and a second connection module (106), characterized in that the first connection module (100) and the second connection module (106) each include a capture and/or release section that is active in a capture and/or release phase and a guide section that is active in a guide phase, and the first connection module (100) and the second connection module (106) are lockable in a holding position.

The device may be designed to vertically launch, vertically land, and/or handle an aerial vehicle in an automatic, independent, and/or autonomous manner. The device may be designed to vertically launch, vertically land, and/or handle an aerial vehicle, in whole or in part, without the involvement of a human user. In the present context, vertical take-off and/or vertical landing refer(s) in particular to taking off and/or landing without a take-off and/or landing strip. During handling, the spatial position and orientation of the aerial vehicle may be changed; for example, the aerial vehicle may be rotated or turned, or the aerial vehicle may also be held upside down.

The device, the first connection module, and/or the second connection module may have a longitudinal axis. The device may be designed for vertical take-off and/or vertical landing at least approximately in the direction of extension of the longitudinal axis. Unless stated otherwise or following otherwise from the context, the terms “axial,” “radial,” and “in the circumferential direction” refer to a direction of extension of the longitudinal axis. “Axial” then corresponds to a direction of extension of the longitudinal axis. “Radial” is then a direction that is perpendicular to the direction of extension of the longitudinal axis and that intersects the longitudinal axis. “In the circumferential direction” then corresponds to a circular arc direction about the longitudinal axis. The device, the first connection module, and/or the second connection module may have a design that is at least approximately rotationally symmetrical with respect to the longitudinal axis.

The first connection module and the second connection module may be designed for mutual connection. The first connection module and the second connection module may form a connecting device. The capture and/or release sections may be designed to assist and/or enable a lift-off of the aerial vehicle during take-off in the release phase, and/or to assist and/or enable a touchdown of the aerial vehicle during landing in the capture phase. The guide sections may be designed to linearly guide the aerial vehicle during take-off, prior to the release phase, and/or during landing, after the capture phase. The first connection module and the second connection module may be brought into the holding position during take-off prior to the guide phase, and/or during landing after the guide phase. In the holding position, the first connection module and the second connection module may be mechanically connected to one another in a defined force-fit and/or form-fit manner. In the holding position, the first connection module and the second connection module may be lockable to one another in the three-dimensional space. In the holding position, the first connection module and the second connection module may be lockable to one another in all six degrees of freedom.

The first connection module may include an inner cone section. The first connection module may include an opening side and an inner side in the axial direction. The inner cone section may be situated at the first connection module on the opening side. The inner cone section may have a funnel-shaped design. The inner cone section may have a truncated cone-shaped design. The inner cone section may have a large opening on the opening side, and a small opening on the inner side. The inner cone section may have an opening cross section that decreases from the opening side toward the inner side. The inner cone section may include sections having different opening angles. The inner cone section may include a section having a smaller opening angle on the opening side, and a section having a larger opening angle on the inner side. The inner cone section may have at least one opening angle of approximately 30° to approximately 130°, in particular approximately 45° to approximately 130°, in particular approximately 50° to approximately 130°, in particular approximately 70°. The inner cone section may act as a capture and/or release section.

The first connection module may include a hollow cylindrical section. The hollow cylindrical section may be situated at the first connection module, on the inner side. The hollow cylindrical section may have an opening cross section that corresponds, at least approximately, to the small opening of the inner cone section. The hollow cylindrical section may have an opening cross section that is constant in the axial direction. The hollow cylindrical section may include a base on the inner side. The hollow cylindrical section may act as a guide section. The hollow cylindrical section may be designed for linear guiding. The hollow cylindrical section may be designed to guide in the axial direction.

The second connection module may include a bolt section. The second connection module may have a distal end and a proximal end in the axial direction. The bolt section may be situated at the distal end of the second connection module. The bolt section of the second connection module and the hollow cylindrical section of the first connection module may correspond to one another. The bolt section of the second connection module and the hollow cylindrical section of the first connection module may correspond to one another in a geometrically complementary manner. The bolt section may have a cross section that at least approximately corresponds to the opening cross section of the hollow cylindrical section of the first connection module. The bolt section may have an opening cross section that is constant in the axial direction. The bolt section may have a bevel at the distal end side. The bolt section may act as a capture or release section and as a guide section. The bolt section may act both as a capture or release section and as a guide section.

The second connection module may include an outer cone section. The outer cone section of the second connection module and the inner cone section of the first connection module may correspond to one another. The outer cone section of the second connection module and the inner cone section of the first connection module may correspond to one another in a geometrically complementary manner.

The first connection module may have toothing. The second connection module may have toothing. The toothing of the first connection module and the toothing of the second connection module may correspond to one another. The toothing of the first connection module and the toothing of the second connection module may correspond to one another in a geometrically complementary manner. The toothing of the first connection module and the toothing of the second connection module may be active in the holding position. The toothing of the first connection module and the toothing of the second connection module may be active in the guide phase for alignment, in particular in the circumferential direction. The toothing of the first connection module and the toothing of the second connection module may be active in the holding position for defined holding, in particular in the circumferential direction. The toothing of the first connection module and the toothing of the second connection module may be engageable and/or disengageable in the axial direction. The toothing of the first connection module and/or the toothing of the second connection module may be designed for simplified insertion. The toothing of the first connection module and/or the toothing of the second connection module may have insertion geometries. The insertion geometries may have a wedge-shaped design. The insertion geometries may be active for engagement and/or in disengagement.

The toothings may be active between the inner cone section and the outer cone section. The toothing of the first connection module may be situated at the inner cone section. The toothing of the second connection module may be situated at the outer cone section. The toothings may have a rhomboidal, diamond-shaped, circular, or ellipsoidal design. The toothings may be situated circumferentially in the circumferential direction. The toothings may be joinable and/or separable in the axial direction.

The device may include a locking and/or releasing device. The locking and/or releasing device may be active between the first connection module and the second connection module. The locking and/or releasing device may be active in the translatory direction and/or in the rotatory direction. The locking and/or releasing device may be active in the translatory direction and/or in the rotatory direction relative to the longitudinal axis. The locking and/or releasing device may be active axially and/or in the circumferential direction. The locking and/or releasing device may be switchable between a locked position and a released position. The locked position may be a preferred position. The locking and/or releasing device may be locking in a passive or unactuated manner. The locking and/or releasing device may be releasing in an active or actuated manner. The locking and/or releasing device may be spring-loaded in the direction of the locked position. The locking and/or releasing device may include an actuator. The actuator may be designed to act on the locking and/or releasing device in the direction of the released position. The actuator may be designed to act on the locking and/or releasing device opposite an elastic force. The locking and/or releasing device may include at least one lever element. The at least one lever element may be spring-loaded and/or actuatable by an actuator. The locking and/or releasing device may include a gear. The gear may be situated between the actuator and the at least one lever element. The gear may be designed for force and/or motion conversion. The gear may include at least one further lever element. The gear may include at least one push rod. The locking and/or releasing device may be switchable by remote control, automatedly, and/or manually.

The locking and/or releasing device may include at least one undercut section. The at least one undercut section and the at least one lever element may be designed to cooperate. The at least one lever element may be situated at the second connection module. The at least one lever element may be situated at the bolt section of the second connection module. The at least one undercut section may be situated at the first connection module. The at least one undercut section may be situated at the cylinder section of the first connection module.

The device may include at least one signal interface and/or power interface. The device may include at least one electrical signal interface and/or power interface. The at least one signal interface and/or power interface may be active between the first connection module and the second connection module. The at least one signal interface and/or power interface may be hard-wired or wireless. The at least one signal interface and/or power interface may include an antenna. The at least one signal interface and/or power interface may be unidirectional or bidirectional.

The device may include at least one sensor or switch. The at least one sensor or switch may be active between the first connection module and the second connection module. The at least one sensor may be an optical sensor, in particular a camera such as an RGB camera. The at least one switch may be an electrical switch. The device may include at least one signal output element, in particular at least one optical signal output element such as a light emitting diode (LED). The device may include a heating device. The first connection module and/or the second connection module may include a housing. The housing may be watertight. The second connection module may include a landing platform for an aerial vehicle.

The first connection module may be situated at an aerial vehicle. The first connection module may be situated at a fuselage of an aerial vehicle. The first connection module may be situated, at least approximately, at a center of gravity of an aerial vehicle or near the center of gravity. The first connection module may be structurally integrated into an aerial vehicle. The first connection module may be a passive module. The second connection module may be designed as an end effector. The second connection module may be designed as an end effector for a robot. The second connection module may include a connecting flange for connection to a robot. The second connection module may include an electrical control device. The control device may include at least one processor, at least one working memory, at least one data memory, at least one signal input, and/or at least one signal output. The second connection module may be an active module. The first connection module and the second connection module may be interchangeably situated. The first connection module may be designed as an end effector. The second connection module may be situated at an aerial vehicle.

The aerial vehicle may have vertical take-off and landing (VTOL), short take-off and landing (STOL), short take-off and vertical landing (STOVL), vertical/short take-off and landing (VSTOL), and/or vertical take-off, horizontal landing (VTHL) capabilities. The aerial vehicle may be a convertiplane. The aerial vehicle may be an aircraft, a rotorcraft, a helicopter, a gyrodyne, a drone, or a rocket. The aerial vehicle may be manned or unmanned. The aerial vehicle may be a fixed-wing aircraft. In this context, the term “fixed-wing aircraft” is used in particular to differentiate from gyroplanes. The aerial vehicle may be a fixed-wing aircraft that is able to take off and land vertically. The aerial vehicle may include a fuselage with fixed airfoils. The aerial vehicle may be designed to create lift during a forward motion of the aerial vehicle by deflecting a necessary air flow at the airfoils. For this purpose, the airfoils may have a suitable profile and/or attack angle.

The end effector may be designed as the last element of a kinematic chain of the robot. The robot may include multiple members. The robot may include multiple articulated joints. The robot may include drives that are associated with the members and/or the articulated joints. The members may be connected to one another with the aid of the articulated joints. The members and articulated joints may form the kinematic chain. The robot may include an electrical control device. The robot may be a kinetic automat. The robot may be programmable. The robot may include multiple, in particular at least three, in particular six, freely movable axes. The robot may be a serial articulated robot that includes six or more articulated joints.

In summary, and stated in other words, the present invention results in, among other things, a robotic gripping device for handling and full automation of take-offs and landings of vertical take-off unmanned flight systems.

On the end effector side, i.e., at a tool flange of a robotic arm, the gripping device may include a truncated cone having an opening angle of 70° or 50° to 130°, and which at the tapering top side may include a beveled cylinder or mandrel. The truncated cone or the thickening downstream from the beveled cylinder may also have a design that is circular or with some other shape, since initial sliding by the cylinder takes place, and the subsequent shape at the mandrel results in an additional form fit for the power transmission. The selection of the shape of the thickening and of the transition between the cylinder and the thickened area may be determined on an application-specific basis.

One or multiple folding barbs that may be disengaged via a coil spring may be installed in the cylinder. The structure may thus be predominantly locked. The locking may also be enabled with the aid of extendable bolts or teeth in the truncated cone. The teeth and the mandrel may be beveled to ensure a precise engagement of the mandrel into the funnel without tilting. Depending on the requirements, a lock may also be provided in the funnel, for example above the insertion tip or in the cone lateral surface, a lock on the tool side and a passive adapter on the flying device side being advantageous to keep the weight of the flying device low.

On the flying device side, a truncated cone lateral surface with a circumferential pattern of axial grooves may be integrated into the fuselage of the flying device. The form of the axial grooves may be based on various shapes, for example triangles, circles, polygons, or mixed forms made up of a trapezoid and a triangle, for example. The truncated cone lateral surface may have an opening angle of 70° or 50° to 110°, for example, and due to its shape may also be referred to as a funnel.

In addition, a tactile sensor, pressure sensor, or switch may be installed at the tip of the mandrel or at the cone lateral surfaces or the teeth, which when triggered allows recognition of a completed landing.

For optimal handling of the flying device by the robot, i.e., for reducing a load on the robot, the funnel may be mounted as close as possible to the center of gravity of the flying device. Alternatively, the arrangement of the funnel and the mandrel may also be interchanged; similarly, it would likewise be possible to place a funnel on the end effector side, and a mandrel on the flying device side.

The funnel may be provided with a tooth shape that is the same as or that matches the funnel in order to ensure locking of the flying device about its yaw axis. Grooves and springs may be provided, which may taper in the direction of the cylinder at the upper end of the mandrel. Tapering of the teeth in the direction of the base of the truncated cone and of the truncated cone lateral surface may increase fatigue strength. Furthermore, this tapering may reduce the risk of catching for additionally introduced holes or depressions in the truncated cone lateral surfaces when guiding the mandrel out of the funnel.

The gripping mechanism may include at least one cylindrical mandrel and at least one truncated cone with radial toothing, which, paired with the radial grooves in the cylinder, results in a form-fit connection. This form-fit connection may be self-centering and may limit all six degrees of freedom of the flying device. The number of teeth or the spacing may be selected in such a way that the funnel rests precisely on the mandrel and is locked by the teeth, even at fairly high relative speeds between the mandrel and the funnel of 0.2 to 2.0 m/s, for example.

For this purpose, an angular distance between the tooth and the groove or tooth recesses may be restricted.

The gripping mechanism allows defined locking of all six degrees of freedom, so that the flying device may be moved and rotated in all spatial directions via the robotic arm. In addition, a defined contact for data or power transmission is ensured.

The gripping mechanism is characterized in particular by the following features: form-fit, self-centering, self-locking; forgiving with respect to position deviations (up to the funnel radius) due to the pairing of the mandrel and the funnel; high repeat accuracy; locks without current, voltage required only for opening; limits all six degrees of freedom of the flying device; heatable to allow, for example, freedom from ice and functioning under all weather conditions; weather-resistant to wind, temperature fluctuations, moisture, dirt, light; the funnel is passive on the flying device side and has a lightweight design for weight reduction; may be opened and closed by remote control, automatedly, and manually; bidirectional wireless data transmission; bidirectional contact-type data transmission from, and power transmission to, the flying device.

By use of the present invention, a device for the automated vertical take-off, vertical landing, and/or handling of an aerial vehicle with the aid of a robot is provided which has a simple design and is easily and rapidly manufacturable and installable.

The device may be used in the areas of agriculture, rail, construction, mining, or security, or for deployment by fire departments, police, and/or military, for aerial photography, terrain monitoring from the air, inspection from the air, and for fully automated flyovers as a service at a desired point in time, so that a customer does not have to own a flying device, and ultimately obtains flight data that are evaluated in a cloud as the end product, for rapid and unmanned goods transport and/or from other manufacturers and operators of unmanned flying devices by establishing a standard interface for automated take-offs and landings with the aid of a robotic arm.

### BRIEF DESCRIPTION OF THE DRAWINGS

Exemplary embodiments of the present invention are described in greater detail below with reference to the figures, which are shown schematically and by way of example.

FIG. 1 shows a first connection module of a device for the automated take-off, landing, and/or handling of a vertical take-off and landing aerial vehicle with the aid of a robot;

FIG. 2 shows a second connection module of a device for the automated take-off, landing, and/or handling of a vertical take-off and landing aerial vehicle with the aid of a robot; and

FIG. 3 shows a device for the automated take-off, landing, and/or handling of a vertical take-off and landing aerial vehicle together with a first connection module and a second connection module, in a sectional view.

### DETAILED DESCRIPTION

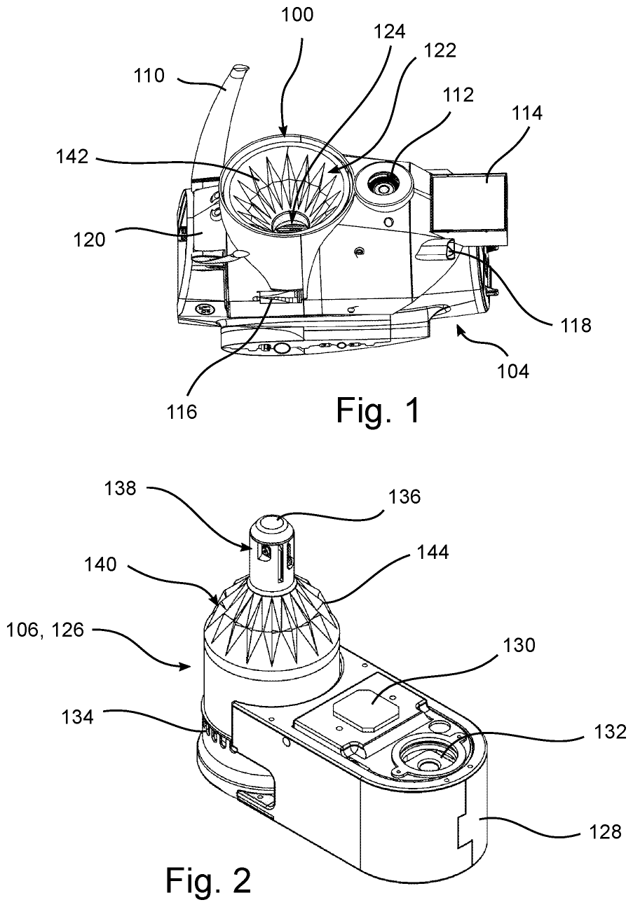

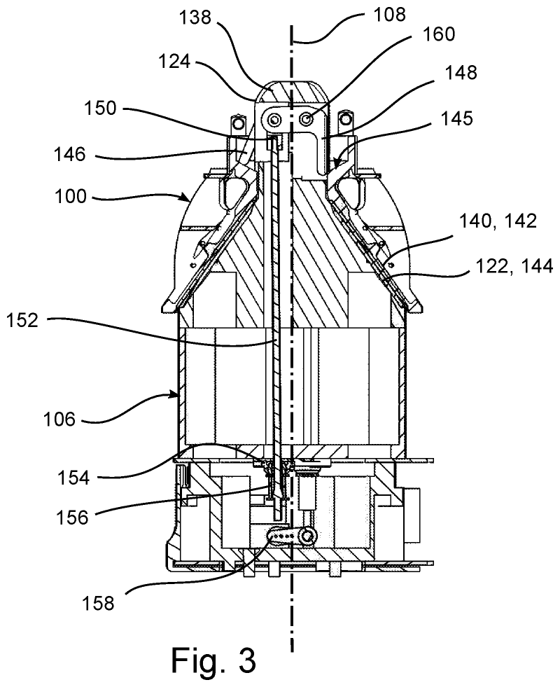

FIG. 1 shows a first connection module 100 of a device 102 for the automated take-off, landing, and/or handling of a vertical take-off and landing aerial vehicle 104, shown in detail in FIG. 1, with the aid of a robot. FIG. 2 shows a second connection module 106 of device 102. FIG. 3 shows device 102 in a holding position in which first connection module 100 and second connection module 106 are connected to one another, in a sectional view. Device 102 has a longitudinal axis 108, and is used to launch, land, and/or handle aerial vehicle 104 with the aid of a robot.

First connection module 100 is situated at a fuselage of aerial vehicle 104 (see, e.g, FIG. 1). Aerial vehicle 104 includes a landing gear 110 for conventional landings, in particular also emergency landings. Aerial vehicle 104 includes a payload 112, for example a camera such as an RGB camera, multispectral camera, infrared camera, or a measuring device, for example using LIDAR. Aerial vehicle 104 includes a surface 114 for optical markers such as ArUco, AprilTags, or the like, for exact relative position determination, in particular via a camera at second connection module 106. Aerial vehicle 104 includes an air inlet 116 and an air outlet 118 for cooling electronic components. Aerial vehicle 104 includes an aerodynamically shaped cover 120.

On the opening side, first connection module 100 includes a funnel-shaped inner cone section 122 that acts as a capture and/or release section, having an opening angle of approximately 70°, and on the inner side includes a hollow cylindrical section 124 that acts as a guide section, having an opening cross section that is constant in the axial direction.

Second connection module 106 is designed as an end effector 126 for a robot. Second connection module 106 or end effector 126 includes a housing 128. Housing 128 has a watertight design. Electronic components for GPS, RTK, telemetry radio, voltage converters, and/or servo control, among other things, are situated in housing 128. Second connection module 106 or end effector 126 includes an antenna 130, in particular a GPS antenna. Second connection module 106 or end effector 126 includes a sensor 132 designed as a camera, such as an RGB camera. Second connection module 106 or end effector 126 includes an optical status indicator 134, which in the present case is designed as an LED ring and is used to display the status of a locking and/or releasing device. End effector 126 includes an electrical signal interface and/or power interface 136, which in the present case is designed as a multipole contact surface for power and/or data transmission.

At its distal end, second connection module 106 includes a bolt section 138 that acts as both a capture or release section and as a guide section, and at its proximal end includes an outer cone section 140. Hollow cylindrical section 124 of first connection module 100 and bolt section 138 of second connection module 106 correspond to one another in a geometrically complementary manner. Inner cone section 122 of first connection module 100 and outer cone section 140 of second connection module 106 correspond to one another in a geometrically complementary manner.

Inner cone section 122 of first connection module 100 and outer cone section 140 of second connection module 106 include toothings 142, 144 that correspond to one another in a geometrically complementary manner. Toothings 142, 144 in each case have insertion geometries with a wedge-shaped design and that act in the axial direction.

The locking and/or releasing device is active between first connection module 100 and second connection module 106, and is switchable between a locked position and a released position. At first connection module 100, the locking and/or releasing device includes an undercut section 145 that extends circumferentially in the circumferential direction and that is active in the axial direction. At second connection module 106, the locking and/or releasing device includes two lever elements 146, 148 with fork joints such as reference numeral 150, rods such as reference numeral 152, guides such as reference numeral 154, compression springs such as reference numeral 156, and actuators designed as servomotors, such as reference numeral 158. Lever elements 146, 148 are each swivelable about a swivel bearing such as reference numeral 160. Rods 152 are each articulately connected to a lever element 146, 148 with the aid of fork joints 150, and are axially displaceably guided with the aid of guides 154. Rods 152 are acted on in the direction of the locked position with the aid of compression springs 156. Rods 152 may be acted on in the direction of the released position, opposite a force of compression springs 156, with the aid of actuators 158. In the locked position, rods 152 are moved downwardly with reference to FIG. 3, and lever elements 146, 148 are swiveled in and removed from the undercut section 145. Lever element 146 is shown in the locked position in FIG. 3. In the released position, rods 152 are moved upwardly with reference to FIG. 3, and lever elements 146, 148 are swiveled out and engage with undercut section 145. Lever 148 is shown in the released position in FIG. 3.

In the holding position shown in FIG. 3, first connection module 100 and second connection module 106 are connected to one another, bolt section 138 of second connection module 106 being accommodated in hollow cylindrical section 124 of first connection module 100, inner cone section 122 of first connection module 100 and outer cone section 140 of second connection module 106 resting against one another, and toothings 142, 144 being engaged with one another, so that aerial vehicle 104 is also accommodated in a defined force-fit and/or form-fit manner with regard to a rotation about longitudinal axis 108. In the holding position, first connection module 100 and second connection module 106 are lockable to one another. When the locking and/or releasing device is switched into the locked position, first connection module 100 and second connection module 106 are locked to one another in all six degrees of freedom, and aerial vehicle 104 may also be handled upside down, for example. For launching aerial vehicle 104, the locking and/or releasing device is switched into the released position, so that first connection module 100 and second connection module 106 may detach from one another. Upon takeoff of aerial vehicle 104, bolt section 138, acting as a guide section, is initially linearly guided at hollow cylindrical section 124, acting as a guide section. As soon as bolt section 138 has left hollow cylindrical section 124, bolt section 138, acting as a release section, and inner cone section 122, acting as a release section, may assist with a lift-off of aerial vehicle 104.

Upon landing of aerial vehicle 104, bolt section 138, acting as a capture section, and inner cone section 122, acting as a capture section, initially assist with a touchdown of aerial vehicle 104. As soon as bolt section 138 is guided into hollow cylindrical section 124, bolt section 138, acting as a guide section, is linearly guided at hollow cylindrical section 124, acting as a guide section, until first connection module 100 and second connection module 106 are connected to one another in the holding position.

The word “may” may refer in particular to optional features of the present invention. Consequently, there are also refinements and/or exemplary embodiments of the present invention which additionally or alternatively have the particular feature or the particular features.

If necessary, individual features may also be selected from the feature combinations disclosed above and used in combination with other features, with resolution of a structural and/or functional relationship possibly existing between the features, for delimiting the subject matter of the claims.

### LIST OF REFERENCE NUMERALS

100 first connection module
102 device
104 aerial vehicle
106 second connection module
108 longitudinal axis
110 landing gear
112 payload
114 surface
116 air inlet
118 air outlet
120 cover
122 inner cone section
124 hollow cylindrical section
126 end effector
128 housing
130 antenna
132 sensor
134 status indicator
136 signal interface and/or power interface
138 bolt section
140 outer cone section
142 toothing
144 toothing
145 undercut section
146 lever element
148 lever element
150 fork joint
152 push rod
154 guide
156 compression spring
158 actuator
160 swivel bearing

What is claimed is:

1-14. (canceled)

15. A device for automated vertical take-off, vertical landing, or handling of an aerial vehicle with the aid of a robot, the device comprising:
a first connection module; and
a second connection module, the first connection module and the second connection module each including a capture or release section active in a capture or release phase and a guide section active in a guide phase, the first connection module and the second connection module being lockable in a holding position.

16. The device as recited in claim 15 wherein the first connection module includes an inner cone section defining the capture or release section and a hollow cylindrical section defining the guide section of the first connection module, and the second connection module includes a bolt section defining the capture or release section and the guide section of the second connection module.

17. The device as recited in claim 16 wherein the second connection module includes an outer cone section corresponding to the inner cone section of the first connection module.

18. The device as recited in claim 15 wherein the first connection module and the second connection module include toothings active in the holding position.

19. The device as recited in claim 18 wherein the second connection module includes an outer cone section corresponding to the inner cone section of the first connection module and the toothings are active between the inner cone section and the outer cone section.

20. The device as recited in claim 18 wherein the toothings have a rhomboidal, diamond-shaped, circular, or ellipsoidal design.

21. The device as recited in claim 15 further comprising includes a lock or release device active between the first connection module and the second connection module.

22. The device as recited in claim 21 wherein the lock or release device is passively locking and actively releasing.

23. The device as recited in claim 21 wherein the lock or release device includes at least one lever spring-loaded or actuatable by an actuator.

24. The device as recited in claim 15 further comprising at least one signal interface or power interface active between the first connection module and the second connection module.

25. The device as recited in claim 15 further comprising at least one sensor or switch active between the first connection module and the second connection module.

26. The device as recited in claim 15 wherein the first connection module is structurally integrated into an aerial vehicle.

27. The device as recited in claim 15 wherein the second connection module is designed as an end effector.

28. An aerial vehicle, the aerial vehicle being capable of automatedly vertically taking off, vertically landing, or being handled with the aid of a robot, the aerial vehicle comprising the first connection module or the second connection module of the device as recited in claim 15.

29. An end effector for a robot for the automated vertical take-off, vertical landing, or handling of an aerial vehicle, the end effector comprising the first connection module or the second connection module of the device as recited in claim 15.
